(19) United States
(12) Patent Application Publication
(10) Pub. No.: US 2026/0183752 A1
(43) Pub. Date: Jul. 2, 2026

(54) GAS DECOMPOSITION CATALYST AND METHOD AND SCRUBBER SYSTEM FOR DECOMPOSING NITROUS OXIDE (N2O) GAS BY USING THE SAME

(71) Applicant: Samsung Electronics Co., Ltd., Suwon-si (KR)

(72) Inventors: Junkyu Kim, Suwon-si, (KR); Su Keun Kuk, Suwon-si, (KR); Hyukjae Kwon, Suwon-si, (KR); Jongmin Lee, Suwon-si, (KR); Mijong Kim, Suwon-si, (KR); Hyunsik Kim, Suwon-si, (KR); Joonwoo Park, Suwon-si, (KR); Hyunwoo Park, Suwon-si, (KR); Inchan Baek, Suwon-si, (KR); Youhwan Son, Suwon-si, (KR)

(21) Appl. No.: 19/413,032

(22) Filed: Dec. 9, 2025

(30) Foreign Application Priority Data
Dec. 31, 2024 (KR) 10-2024-0202730

(51) Int. Cl. B01J 23/745; B01D 53/86; B01J 23/75; B01J 23/755; B01J 35/45; B01J 35/64; B01J 35/70; B01J 37/04; B01J 37/08

(52) U.S. Cl. CPC B01J 23/745; B01D 53/8625; B01J 23/75; B01J 23/755; B01J 35/45; B01J 35/647; B01J 35/733; B01J 37/04; B01J 37/08; B01D 2257/402

(57) ABSTRACT

A gas decomposition catalyst and a method and scrubber system for decomposing nitrous oxide gas by using the gas decomposition catalyst. The gas decomposition catalyst includes a perovskite-based oxide host material represented by Formula 1, in which a B′ element and a B″ element which are different from each other are each doped into a B site, and one or more B′ element protrusion particles derived from a portion or all of the B′ element on a surface of the perovskite-based oxide host material, where the one or more B′ element protrusion particles have a shape in which a portion of one particle is fixed inside the perovskite-based oxide host material and another portion of the one particle protrudes from the surface of the perovskite-based oxide host material:

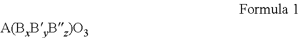

In Formula 1, A, B, B′, B″, x, y, and z are as described herein.

### CROSS-REFERENCE TO RELATED APPLICATION

This application is based on and claims priority to Korean Patent Application No. 10-2024-0202730, filed on Dec. 31, 2024, in the Korean Intellectual Property Office, and all the benefits accruing therefrom under 35 U.S.C. § 119, the content of which is incorporated by reference herein in its entirety.

### BACKGROUND

### 1. Field

The disclosure relates to a gas decomposition catalyst and a method and scrubber system for decomposing nitrous oxide gas by using the gas decomposition catalyst and scrubber system.

### 2. Description of the Related Art

Nitrous oxide (N₂O) has a very high global warming potential that is about 310 times that of carbon dioxide (CO₂). However, nitrous oxide (N₂O) is chemically stable and thus minimally reduced in the troposphere, but also decomposed in the stratosphere by ultraviolet rays from the sun or reacts with oxygen in the air to produce nitric oxide (NO) and nitrogen dioxide (NO₂).

Decomposition of nitrous oxide (N₂O) is mainly used to treat vehicle exhaust gases, semiconductor process gases, or display process gases. In these industries, reduction processes of reducing nitrous oxide (N₂O) emissions are essential to achieve carbon neutrality. Research on decomposition of nitrous oxide (N₂O) is being widely conducted to reduce nitrous oxide (N₂O) emissions.

Examples of nitrous oxide (N₂O) decomposition technologies may include thermal decomposition technologies using high-temperature heating and direct decomposition technologies using catalysts. In thermal decomposition technologies using high-temperature heating, due to a high operating temperature of 1,000° C. or more for nitrous oxide (N₂O) decomposition, it is difficult to manage heat and energy.

Therefore, there is a need for a gas decomposition catalyst that is thermally and chemically stable in an operating environment for nitrous oxide (N₂O) decomposition and has improved nitrous oxide (N₂O) decomposition performance, and a method and scrubber system for decomposing nitrous oxide gas by using the same.

### SUMMARY

Provided is a gas decomposition catalyst which is thermally and chemically stable in an operating environment for nitrous oxide (N₂O) decomposition and has improved nitrous oxide (N₂O) decomposition performance.

Provided is a method of decomposing nitrous oxide gas by using the gas decomposition catalyst.

Provided is a scrubber system of decomposing nitrous oxide gas by using the gas decomposition catalyst.

Additional aspects will be set forth in part in the description which follows and, in part, will be apparent from the description, or may be learned by practice of the presented embodiments of the disclosure.

According to an aspect of the disclosure, a gas decomposition catalyst includes a perovskite-based oxide host material represented by Formula 1, in which a B′ element and a B″ element which are different from each other are each doped into a B site, and one or more B′ element protrusion particles derived from a portion or all of the B′ element on a surface of the perovskite-based oxide host material, where the one or more B′ element protrusion particles have a shape in which a portion of one particle is fixed inside the perovskite-based oxide host material and another portion of the one particle protrudes from the surface of the perovskite-based oxide host material:

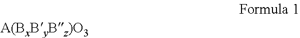

wherein, in Formula 1,
A may be at least one element of strontium (Sr) or lanthanum (La),
B may be at least one of metals (e.g., transition metals) having an oxidation number of +3, +4, or +5,
B′ may be at least one of elements of which Gibbs free energy

$$( Δ {G}_{red}^{900 C} )$$

of a reduction reaction at a temperature of 900° C. according to Reaction Formula 1 below is 0 or less,
B″ may be at least one element of zirconium (Zr), hafnium (Hf), niobium (Nb), tantalum (Ta), gadolinium (Gd), scandium (Sc), or titanium (Ti),
x, y, and z may each be a rational number that is greater than 0 and less than 1, and
x+y+z=1.

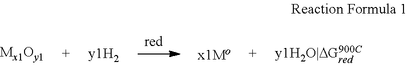

wherein, in Reaction Formula 1,
x1 and y1 may each be a positive rational number, and
M may be a metal.

According to another aspect of the disclosure, a method of decomposing nitrous oxide (N₂O) gas includes decomposing nitrous oxide (N₂O) gas by contacting a gas including nitrous oxide gas, e.g., a process gas, with a gas decomposition catalyst, where the gas decomposition catalyst includes a perovskite-based oxide host material represented by Formula 1, in which a B′ element and a B″ element that are different from each other are each doped into a B site, and one or more B′ element protrusion particles derived from a portion or all of the B′ element on a surface of the perovskite-based oxide host material. The one or more B′ element protrusion particles have a shape in which a portion of one particle is fixed inside the perovskite-based oxide host material and another portion of the one particle protrudes from the surface of the perovskite-based oxide host material:

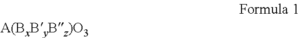

wherein, in Formula 1,
A may be at least one element of strontium (Sr) or lanthanum (La),
B may be at least one of metals (e.g., transition metals) having an oxidation number of +3, +4, or +5,
B′ may be at least one of elements of which Gibbs free energy

$$( Δ {G}_{red}^{900 C} )$$

of a reduction reaction at a temperature of 900° C. according to Reaction Formula 1 below is 0 or less,
B″ may be at least one element selected from zirconium (Zr), hafnium (Hf), niobium (Nb), tantalum (Ta), gadolinium (Gd), scandium (Sc), or titanium (Ti),
x, y, and z may each be a rational number that is greater than 0 and less than 1, and
x+y+z=1:

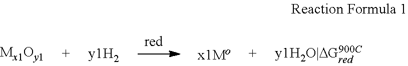

wherein, in Reaction Formula 1,
x1 and y1 may each be a positive rational number,
red is reduction, and
M may be a metal.

According to another aspect of the disclosure, a scrubber system for decomposing nitrous oxide (N₂O) gas includes a gas inlet through which a process gas flows in, a scrubber including a gas decomposition catalyst which decomposes nitrous oxide (N₂O) gas from the process gas flowing in from the gas inlet, and a gas outlet through which a gas, from which the nitrous oxide (N₂O) gas is removed, flows out from the scrubber, where the gas decomposition catalyst includes a perovskite-based oxide host material represented by Formula 1, in which a B′ element and a B″ element that are different from each other are each doped into a B site, and one or more B′ element protrusion particles derived from a portion or all of the B′ element on a surface of the perovskite-based oxide host material. The one or more B′ element protrusion particles have a shape in which a portion of one particle is fixed inside the perovskite-based oxide host material and another portion of the one particle protrudes from the surface of the perovskite-based oxide host material:

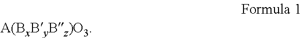

wherein, in Formula 1,
A may be at least one element of strontium (Sr) or lanthanum (La),
B may be at least one of metals (e.g. transition metals) having an oxidation number of +3, +4, or +5,
B′ may be at least one of elements of which Gibbs free energy

$$( Δ {G}_{red}^{900 C} )$$

of a reduction reaction at a temperature of 900° C. according to Reaction Formula 1 below is 0 or less,
B″ may be at least one element of zirconium (Zr), hafnium (Hf), niobium (Nb), tantalum (Ta), gadolinium (Gd), scandium (Sc), or titanium (Ti),
x, y, and z may each be a rational number that is greater than 0 and less than 1, and x+y+z=1:

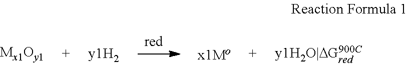

wherein, in Reaction Formula 1,

x1 and y1 may each be a positive rational number,

red is reduction, and
M may be a metal.

### BRIEF DESCRIPTION OF THE DRAWINGS

The above and other aspects, features, and advantages of certain embodiments will be more apparent from the following description taken in conjunction with the accompanying drawings, in which:

FIG. 1 is a schematic cross-sectional view illustrating a comparison between a shape of a B′ element particle (B′ element protrusion particle) ex-solutioned to the surface from the inside of a perovskite-based oxide host material and a shape of a B′ particle deposited on the surface of the perovskite-based oxide host material, according to an embodiment;

FIG. 2 is a schematic flowchart of a method of preparing a gas decomposition catalyst according to an embodiment;

FIG. 3A is a graph showing intensity (arbitrary unit, a.u.) versus diffraction angle (2θ, degree) of the results of X-ray diffraction (XRD) analysis of a crystal structure before reduction of each of perovskite-based oxide gas decomposition catalysts prepared in Reference Example 1 and Examples 1 to 4;

FIG. 3B is a graph showing intensity (arbitrary unit, a.u.) versus diffraction angle (2θ, degree) of the results of XRD analysis of a crystal structure after reduction of each of the perovskite-based oxide gas decomposition catalysts prepared in Reference Example 1 and Examples 1 to 4;

FIG. 4 shows results of scanning electron microscope (SEM) analysis of a surface after reduction of each of the perovskite-based oxide gas decomposition catalysts prepared in Reference Example 1 (Ti) and Examples 1 to 4 (Zr, Hf, Nb, and Ta);

FIG. 5 is a schematic view of a nitrous oxide (N₂O) gas decomposition system used to evaluate nitrous oxide (N₂O) gas decomposition performance in FIGS. 6 and 7;

FIG. 6 is a graph showing converted nitrous oxide (N₂O) (moles per second, mole/s) versus temperature (Celsius, ° C.) of the results of the nitrous oxide (N₂O) gas decomposition performance according to a temperature of each of the perovskite-based oxide gas decomposition catalysts prepared in Reference Example 1 and Examples 1 to 4;

FIG. 7 is a bar graph showing converted nitrous oxide (N₂O) (moles per second, mole/s) at a temperature of 800° C. of the results of the nitrous oxide (N₂O) gas decomposition performance of each of the perovskite-based oxide gas decomposition catalysts prepared in Reference Example 1 and Examples 1 to 4; and

FIG. 8 is a schematic view of a scrubber system for decomposing nitrous oxide (N₂O) gas, according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Hereinafter, as the present inventive concept allows for various changes and numerous embodiments, specific embodiments will be illustrated in the drawings and described in detail in the written description. However, this is not intended to limit the present inventive concept to particular modes of practice, and it is to be appreciated that all changes, equivalents, and substitutes that do not depart from the spirit and technical scope are encompassed in the present inventive concept.

The terms used herein are merely used to describe specific embodiments and are not intended to limit the present inventive concept. An expression used in the singular encompasses the expression of the plural, unless it has a clearly different meaning in the context.

The expression “at least one” or “one or more” used in front of components in the present specification is meant to supplement a list of all components means, and does not imply to supplement individual components of the description. The term “combination” as used herein includes mixtures, alloys, reaction products, or the like, unless specifically stated otherwise. It will be understood that unless otherwise stated herein, the terms “comprises” and/or “comprising,” or “includes” and/or “including” do not preclude other elements, but further include other elements. As used herein, terms “first,” “second,” and the like are used to distinguish one component from another, without indicating order, quantity, or importance. As used herein, unless otherwise indicated or explicitly contradicted by context, it should be interpreted as including both singular and plural. The term “or” means “and/or” unless otherwise specified.

Throughout the present specification, “an embodiment,” “example embodiment,” “embodiment,” and the like. are included in at least an embodiment in which specific elements described in connection with the embodiment are included in this specification, which means that these elements may or may not exist in another embodiment. Further, it should be understood that the described elements may be combined in any suitable manner in various embodiments.

All percent, parts, ratios and the like are by weight unless otherwise indicated. Further, when an amount, concentration, or other value or parameter, is given as a list of upper desirable values and lower desirable values, this is to be understood as specifically disclosing all ranges formed from any pair of an upper desirable value and a lower desirable value, regardless of whether ranges are separately disclosed.

When a range of numerical values is described herein, unless stated otherwise, the range is intended to include the terminal points thereof, and all integers and fractions within the range. The scope of the disclosure is not intended to be limited to the specific values mentioned when defining a range.

Unless otherwise specified, the unit “parts by weight” refers to a weight ratio between respective components, and the unit “parts by mass” refers to a value in which a weight ratio between respective components is converted into solid.

“About” as used herein is inclusive of the stated value and means within an acceptable range of deviation for the particular value as determined by one of ordinary skill in the art, considering the measurement in question and the error associated with measurement of the particular quantity (that is, the limitations of the measurement system). For example, “about” may mean within one or more standard deviations, or within ±30%, 20%, 10%, 5%, or 3% of the stated value.

Unless otherwise defined, all terms (including technical and scientific terms) used herein have the same meaning as commonly understood by one or ordinary skill in the art to which the disclosure belongs. In addition, it will be further understood that terms, such as those defined in commonly used dictionaries, should be interpreted as having a meaning that is consistent with their meaning in the context of the relevant art and the disclosure and will not be interpreted in an idealized sense unless expressly so defined herein. Also, the terms should not be interpreted in an overly formal sense.

Embodiments are described herein with reference to cross-sectional views which are schematic diagrams of idealized embodiments. Therefore, the appearance of the example may vary, for example, as a result of manufacturing techniques and/or tolerances. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, regions illustrated in the drawings are schematic in nature and their shapes are not intended to illustrate the actual shape of a region and are not intended to limit the scope of the claims.

Among nitrous oxide (N₂O) decomposition technologies, as compared to a thermal decomposition technology, a direct decomposition technology using a catalyst may be used at a relatively low temperature of about 600° C. to about 800° C., and energy may be saved. Examples of such a catalyst may include a zeolite catalyst or a supported catalyst in which a precious metal is impregnated or co-precipitated on an alumina oxide support.

However, general catalysts have a problem in that dispersity is low and metal nanoparticles, which are reaction active sites, agglomerate and become coarsening in an operating environment for nitrous oxide (N₂O) decomposition, or nitrous oxide (N₂O) decomposition performance deteriorates due to evaporation.

Based on this point, the inventors of the disclosure will describe in more detail a gas decomposition catalyst, a method of preparing the same, and a method and scrubber system for decomposing nitrous oxide gas by using the gas decomposition catalyst as follows.

### Gas Decomposition Catalyst

A gas decomposition catalyst according to an embodiment may include a perovskite-based oxide host material represented by Formula 1, in which a B′ element and a B″ element that are different from each other are each doped into a B site, and one or more B′ element protrusion particles derived from a portion or all of the B′ element on a surface of the perovskite-based oxide host material:

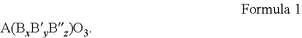

The perovskite-based oxide host material represented by Formula 1 may have a structure in which the B′ element and the B″ element that are different from each other are doped into a B site of perovskite oxide of general ABO₃. The perovskite-based oxide host material represented by Formula 1 may form an elastically stable host phase even when the B′ element and the B″ element with various contents are doped into the B site.

In Formula 1, A may be at least one element of strontium (Sr) or lanthanum (La), and for example, A may be strontium (Sr).

In Formula 1, B may be at least one metals (e.g. transition metals) having an oxidation number of +3, +4, or +5 and may include, for example, an element of titanium (Ti), aluminum (Al), cobalt (Co), iron (Fe), or nickel (Ni).

In Formula 1, B′ may be at least one of elements of which Gibbs free energy

$$( Δ {G}_{red}^{900 C} )$$

of a reduction reaction at a temperature of 900° C. according to Reaction Formula 1 below is 0 or less.

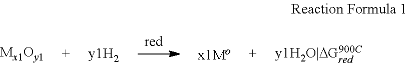

In Reaction Formula 1,
x1 and y1 may each be a positive rational number, and
M may be a metal. For example, M may be at least one of metals (e.g. transition metals) having an oxidation number of +3, +4, or +5.

According to Reaction Formula 1, B′ may refer to an element that undergoes a spontaneous reduction reaction at a high temperature of 900° C.

B′ may form one or more protrusion particles derived from a portion or all of the B′ element on the surface of the perovskite-based oxide host material. Specifically, the B′ element protrusion particles may have a shape in which a portion of one particle is fixed inside the perovskite-based oxide host material and another portion of the one particle protrudes from the surface of the perovskite-based oxide host material. More specifically, the B′ element protrusion particles may have a shape in which a portion of one particle is embedded inside and on the surface of the perovskite-based oxide host material.

The B′ element protrusion particles may have a spherical shape, an ellipsoidal shape, a ring shape, or a cylindrical shape. For example, the B′ element protrusion particles may have a spherical shape or a shape close to a spherical shape.

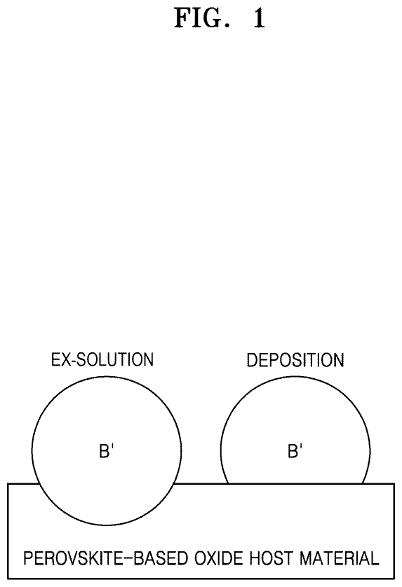

FIG. 1 is a schematic cross-sectional view illustrating a comparison between a shape of a B′ element particle (B′ element protrusion particle) ex-solutioned to the surface of the perovskite-based oxide host material from the inside of the perovskite-based oxide host material and a shape of a B′ particle deposited on the surface of the perovskite-based oxide host material, according to an embodiment.

Referring to FIG. 1, the B′ element protrusion particle may maintain a spherical shape in which a portion of the B′ element protrusion particle is embedded into the perovskite-based oxide host material and another portion of the B′ element protrusion particle protrudes from the surface. The B′ element protrusion particles having such a shape may maintain the number and distribution of particles even after heat treatment at a high temperature of 800° C. or more.

In comparison, the B′ particle deposited on the surface of the perovskite-based oxide host material may have a shape of which a portion may be attached to a surface of perovskite-based oxide, but since the interaction with the perovskite-based oxide host material is insufficient, particles may be coarsening on the perovskite-based oxide host material during a growth reaction, which may deteriorate the performance of a gas decomposition catalyst.

Therefore, the gas decomposition catalyst including the B′ element protrusion particles according to an embodiment may be used in industrial fields involving catalytic reactions at a high temperature of 800° C. or more, for example, in electrochemical applications (hydrogen fuel cells (SOFCs), protonic ceramic fuel cells, alkaline water electrolysis, and the like).

The B′ element protrusion particles may be nanoparticles.

For example, the B′ element of the B′ element protrusion particle may include at least one element of cobalt (Co), nickel (Ni), or iron (Fe). For example, Gibbs free energies ΔG_{red}^{900C} of a reduction reaction at a temperature of 900° C. according to Reaction Formula 1 of CoO, NiO, and Fe₂O₃ are −33.48 kJ mol⁻¹, −51.58 kJ mol⁻¹, and −15.38 kJ mol⁻¹, respectively.

For example, the B′ element protrusion particles may have a size of about 5 nanometers (nm) to about 20 nm. A standard deviation of the size of the B′ element protrusion particles may be ±2 nm. The B′ element protrusion particles may have a size of nanoparticles and a uniform distribution.

As used herein, the “size” of the B′ element protrusion particles is defined as follows according to a cross-sectional shape of a particle. For example, when a cross section of a particle has a “circular shape” like a spherical shape, a ring shape, or a cylindrical shape, the “size” may refer to a “diameter.” For example, when a cross section of a particle has an “ellipsoidal shape,” the “size” may refer to a “length of a major axis.”

For example, the B′ element protrusion particles may have a size of about 5.1 nm to about 19.9 nm, about 5.2 nm to about 19.8 nm, about 5.3 nm to about 19.7 nm, about 5.4 nm to about 19.6 nm, about 5.5 nm to about 19.5 nm, about 5.6 nm to about 19.4 nm, about 5.7 nm to about 19.3 nm, about 5.8 nm to about 19.2 nm, about 5.9 nm to about 19.1 nm, about 6.0 nm to about 19.0 nm, about 6.1 nm to about 18.9 nm, about 6.2 nm to about 18.8 nm, about 6.3 nm to 18.7 nm, about 6.4 nm to about 18.6 nm, about 6.5 nm to about 18.5 nm, about 6.6 nm to about 18.4 nm, about 6.7 nm to about 18.3 nm, about 6.8 nm to about 18.2 nm, about 6.9 nm to about 18.1 nm, or about 7.0 nm to about 18.0 nm.

The size of the B′ element protrusion particles may be measured from a transmission electron microscope (TEM) image or a scanning electron microscope (SEM) image. Alternatively, measurement may be performed by using a measuring device that uses grazing-incidence small-angle X-ray scattering (GISAXS), and data analysis may be performed to count the number of particles for each particle size range so that the size of the B′ element protrusion particles may be obtained from the number of particles through a calculation.

B″ may be an element capable of controlling the size and distribution of the B′ element protrusion particles.

B″ may be at least one element of zirconium (Zr), hafnium (Hf), niobium (Nb), tantalum (Ta), gadolinium (Gd), scandium (Sc), and titanium (Ti), and may be, for example, an element selected from zirconium (Zr), hafnium (Hf), niobium (Nb), or tantalum (Ta).

The B″ element may control the size and distribution of the B′ element protrusion particles because the B′ element moves from the inside of a perovskite oxide lattice to the surface of the perovskite oxide lattice, where it controls the size and distribution of the B′ element protrusion particles through a reduction reaction (electron transfer), adjusting a strain and a binding energy between the B′ element and an oxygen ion. However, one or more embodiments are not limited thereto.

The B′ element protrusion particles may have a density of about 50 per square micrometers (/μm²) to about 1,000/μm² on the surface of the perovskite-based oxide host material. The size and density of the B′ element protrusion particles may supported by SEM analysis results to be described below.

In an embodiment, with respect to a total of 100 atomic percentage (at %) at the B site of the gas decomposition catalyst, that is, a total of 100 at % of a B element, the B′ element, and the B″ element, the B′ element may occupy an amount of more than about 0 at % and up to about 75 at %, for example, about 1 at % to about 50 at %, about 3 at % to about 30 at %, about 5 at % to about 20 at %, about 5 at % to about 15 at %, or about 8 at % to about 12 at %.

In an embodiment, with respect to a total of 100 at % at the B site of the gas decomposition catalyst, that is, a total of 100 at % of the B element, the B′ element, and the B″ element, the B″ element may occupy an amount of more than about 0 at % and up to about 50 at %, for example, about 1 at % to about 40 at %, about 3 at % to about 30 at %, about 5 at % to about 20 at %, about 5 at % to about 15 at %, or about 8 at % to about 12 at %.

The gas decomposition catalyst according to an embodiment may be a catalyst that decomposes nitrous oxide (N₂O) gas.

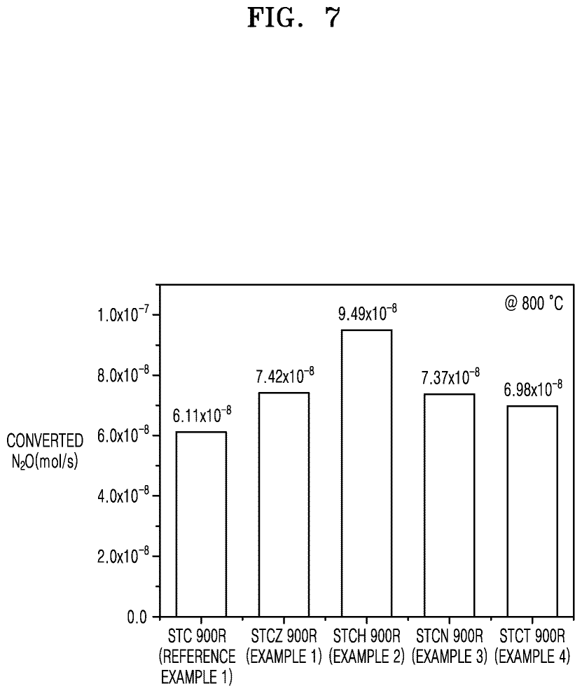

In the decomposition catalyst according to an embodiment, nitrous oxide (N₂O) decomposition performance may be at least about 1.5 times (e.g., 1.6 times) higher than that of a gas decomposition catalyst including an A (BB′O₃) perovskite-based oxide host material in which only a B′ element is doped into a B site, and one or more B′ element protrusion particles derived from a portion or all of the B′ element on a surface of the perovskite-based oxide host material. This is supported by Evaluation Example 3 to be described below and FIG. 7.

### Method of Preparing a Gas Decomposition Catalyst

According to another embodiment, a method of preparing a gas decomposition catalyst may include: synthesizing a perovskite-based oxide host material represented by Formula 1, in which a B′ element and a B″ element which are different from each other are doped into a B site, and performing oxidation heat treatment to obtain a perovskite-based oxide solid solution; and performing reduction heat treatment on the perovskite-based oxide solid solution at a temperature of about 600° C. to about 1,000° C. in a reducing gas atmosphere to form one or more B′ element protrusion particles derived from a portion or all of the B′ element on a surface of the perovskite-based oxide host material to prepare a gas decomposition catalyst, wherein the B′ element protrusion particles may have a shape in which a portion of one particle is fixed inside the perovskite-based oxide host material and another portion of the one particle protrudes from the surface of the perovskite-based oxide host material.

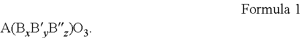

In Formula 1,
A may be at least one element of strontium (Sr) or lanthanum (La),
B may be at least one of metals (e.g. transition metals) having an oxidation number of +3, +4, or +5;
B′ may be at least one elements of which Gibbs free energy

$$( Δ {G}_{red}^{900 C} )$$

of a reduction reaction at a temperature of 900° C. according to Reaction Formula 1 below is 0 or less,
B″ may be at least one of element selected from zirconium (Zr), hafnium (Hf), niobium (Nb), tantalum (Ta), gadolinium (Gd), scandium (Sc), or titanium (Ti),
x, y, and z may each be a rational number that is greater than 0 and less than 1, and
x+y+z=1.

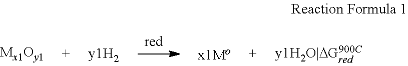

In Reaction Formula 1,
x1 and y1 may each be a positive rational number, and
M may be a metal. For example, M may be at least one of metals (e.g. transition metals) having an oxidation number of +3, +4, or +5.

In the method of preparing a gas decomposition catalyst according to an embodiment, by using a perovskite-based oxide host material, active element B′ protrusion particles may be uniformly distributed and formed on a surface of a perovskite-based oxide host material by performing reduction heat treatment once. The active element B′ protrusion particles may have a shape in which a portion of one particle is fixed inside the perovskite-based oxide host material and another portion of the one particle protrudes from the surface of the perovskite-based oxide host material.

Therefore, a gas decomposition catalyst prepared through the method of preparing a gas decomposition catalyst according to an embodiment may be thermally and chemically stable in an operating environment for nitrous oxide (N₂O) decomposition, may have high durability, and may have improved nitrous oxide (N₂O) decomposition performance.

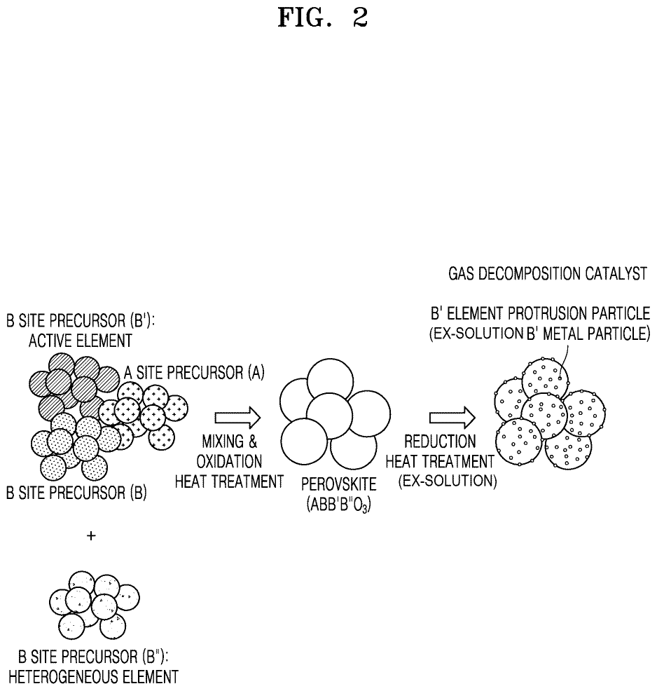

FIG. 2 is a schematic flowchart of the method of preparing a gas decomposition catalyst according to an embodiment.

Referring to FIG. 2, the obtaining of the perovskite-based oxide solid solution (perovskite (ABB′B″O₃)) may include obtaining a mixture by mixing a precursor of an A element, a precursor of a B element, a precursor of the B′ element (active element), and a precursor of the B″ element (heterogeneous element), and performing oxidation heat treatment on the mixture at a temperature of about 800° C. to about 1,500° C. in an air atmosphere.

The precursors of the element A, the element B, the element B′, and the element B″ may each independently be one of a nitrate, a sulfate, an oxalate, a phosphate, an acetate, a carbonate, a citrate, a phthalate, a perchlorate, a hydroxide, an alkoxide, a halide, an oxyhalogenide, an oxide, and a peroxide of each element, or a hydrate thereof.

For example, the A element may be at least one element of strontium (Sr) or lanthanum (La), and for example, A may be strontium (Sr).

For example, the B element may be at least one of metals (e.g., transition metals) having an oxidation number of +3, +4, or +5 and may include, for example, an element of titanium (Ti), aluminum (AI), cobalt (Co), iron (Fe), or nickel (Ni).

For example, the B′ element may include at least one element of cobalt (Co), nickel (Ni), or iron (Fe).

For example, the B″ element may be at least one element of zirconium (Zr), hafnium (Hf), niobium (Nb), tantalum (Ta), gadolinium (Gd), scandium (Sc), or titanium (Ti) and may be, for example, an element of zirconium (Zr), hafnium (Hf), niobium (Nb), or tantalum (Ta).

For example, the precursors of the A element, the B element, the B′ element, and the B″ element may each independently be one of a nitrate, an acetate, a carbonate, a hydroxide, an alkoxide, a halide, and an oxide of each element, or a hydrate thereof.

Water may be used as a solvent to mix the precursor of the A element, the precursor of the B element, the precursor of the B′ element (active element), and the precursor of the B″ element (heterogeneous element), but one or more embodiments are not limited thereto. Any solvent may be used without limitation as long as the solvent may dissolve and disperse a precursor of each element. For example, an alcohol-based solvent such as methanol, ethanol, propanol, or butanol; an acid solvent such as a nitric acid, a hydrochloric acid, or a sulfuric acid; and an organic solvent such as toluene, benzene, acetone, diethyl ether, or ethylene glycol may be used alone or in combination of two or more.

A precursor of each element may be mixed with the solvent at a temperature of about 25° C. to about 300° C., and a mixture may be obtained by performing stirring for a specified period of time such that respective components may be sufficiently mixed with each other. Additives or the like may be added to remove residual solvents and by-products during mixing.

The mixture may be subjected to oxidation heat treatment at a temperature of about 800° C. to about 1,500° C. in an air atmosphere to obtain the perovskite-based oxide solid solution. The air atmosphere may include an oxygen atmosphere. The oxidation heat treatment may be performed in such a temperature range for about 4 hours to about 60 hours, for example, about 5 hours to about 30 hours, to obtain the perovskite-based oxide solid solution. Through such an oxidation heat treatment process, the B′ element derived from a portion or all of the precursor of the B′ element (active element) may be transformed into a solid-solution in the form of a cation inside the perovskite-based oxide host material.

Thereafter, as needed, the perovskite-based oxide solid solution may be ground or pulverized to obtain a nanosized powder-like perovskite-based oxide solid solution. A pulverizing method is not limited, but for example, pulverizing may be performed using a mortar, or the pulverizing method may be one of ball milling, air-jet milling, bead milling, roll milling, hand milling, high-energy ball milling, planetary milling, stirred ball milling, vibrating milling, mechanofusion milling, shaker milling, attritor milling, disk milling, shape milling, nauta milling, nobilta milling, or high-speed mixing. A specific surface area of the nanosized powder-like perovskite-based oxide solid solution may be increased, thereby improving the efficiency of the gas decomposition catalyst.

Next, the perovskite-based oxide host solid solution may be subjected to reduction heat treatment at a temperature of about 600° C. to about 1,000° C. in a reducing gas atmosphere to form one or more B′ element protrusion particles derived from a portion or all of the B′ element on the surface of the perovskite-based oxide host material, thereby preparing a gas decomposition catalyst.

The B′ element protrusion particles may be reduced particles (ex-solution B′ metal particles) formed through ex-solution to the surface from the inside of the perovskite-based oxide host material.

Some or all of the reduced particles (ex-solution B′ metal particles) formed through reduction heat treatment may be embedded into the perovskite-based oxide host material at a volume of about 50% or less, about 40% or less, or about 30% or less of the total volume of the perovskite-based oxide host material. Thus, the gas decomposition catalyst according to an embodiment may be strongly fixed to the surface of the perovskite-based oxide host material and thus may have not only very high thermal and chemical stability but also excellent durability.

The reduction heat treatment may be performed in an atmosphere of a 1 to 100% H₂ gas, a H₂/Ar mixed gas, a H₂/N₂ mixed gas, or a H₂/He mixed gas. A volume ratio of a mixed gas may be in a range of about 1/99 to about 99/1, or for example, the volume ratio of the mixed gas may be in a range of about 3/97 to about 97/3 or about 5/95 to 95/5. Within the above volume ratio range, reduced particles (ex-solution B′ metal particles) having a uniform and even distribution may be smoothly formed.

A reduction heat treatment temperature may be in a range of about 600° C. to about 1,000° C., for example, a range of about 700° C. to about 1,000° C. Within the above range of the reduction heat treatment temperature, the reduced particles (ex-solution B′ metal particles) may be uniformly formed, and a crystal structure of the perovskite-based oxide host material may be maintained.

The reduction heat treatment may be performed for about 1 hour to about 24 hours. For example, the reduction heat treatment may be performed for about 1 hour to about 12 hours. Within such a heat treatment time range, reduced particles (ex-solution B′ metal particles) may be formed uniformly and easily, and the crystal structure of the perovskite-based oxide host material may be maintained.

That is, the gas decomposition catalyst according to an embodiment may maintain the crystal structure of the perovskite-based oxide host material before and after the reduction heat treatment.

The gas decomposition catalyst prepared through the method of preparing a gas decomposition catalyst according to an embodiment may be a catalyst that decomposes nitrous oxide (N₂O) gas.

### Method of Decomposing Nitrous Oxide Gas

According to another embodiment, a method of decomposing nitrous oxide (N₂O) gas may include decomposing nitrous oxide (N₂O) gas by contacting a process gas with a gas decomposition catalyst, wherein the gas decomposition catalyst includes a perovskite-based oxide host material represented by Formula 1, in which a B′ element and a B″ element that are different from each other are each doped into a B site, and one or more B′ element protrusion particles derived from a portion or all of the B′ element on a surface of the perovskite-based oxide host material, wherein the one or more B′ element protrusion particles may have a shape in which a portion of one particle is fixed inside the perovskite-based oxide host material and another portion of the one particle protrudes from the surface of the perovskite-based oxide host material:

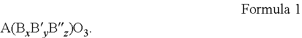

In Formula 1,
A may be at least one element of strontium (Sr) or lanthanum (La),
B may be at least one of metals (e.g. transition metals) having an oxidation number of +3, +4, or +5,
B′ may be at least one of elements of which Gibbs free energy

$$( Δ {G}_{red}^{900 C} )$$

of a reduction reaction at a temperature of 900° C. according to Reaction Formula 1 below is 0 or less,
B″ may be at least one element of zirconium (Zr), hafnium (Hf), niobium (Nb), tantalum (Ta), gadolinium (Gd), scandium (Sc), or titanium (Ti),
x, y, and z may each be a rational number that is greater than 0 and less than 1, and
x+y+z=1.

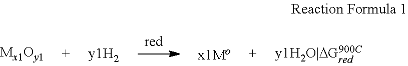

In Reaction Formula 1,
x1 and y1 may each be a positive rational number,
red is reduction, and
M may be a metal.

The process gas may mainly include a semiconductor process gas, but may include a gas emitted during a display manufacturing process, and a flue gas that is a product of combustion in a combustion engine. A contact method is not limited, but for example, a chamber process may be used to cause a contact reaction with the gas decomposition catalyst through a gas flow from a gas inlet.

The method of decomposing nitrous oxide (N₂O) gas according to an embodiment may be performed in a low-temperature operating environment, for example, even at a temperature of about 600° C. to about 800° C., thereby consuming less energy and exhibiting thermally and chemically stable and improved nitrous oxide decomposition performance.

B may be selected differently from B″ and may include at least one element of titanium (Ti), aluminum (AI), cobalt (Co), iron (Fe), or nickel (Ni).

B′ may be selected differently from B and may include at least one element of cobalt (Co), nickel (Ni), or iron (Fe).

B″ may be an element capable of controlling the size and distribution of the B′ element protrusion particles.

In the gas decomposition catalyst according to an embodiment, when reduction heat treatment is performed at a temperature of 900° C. to form the B′ element protrusion particles on the surface of the perovskite-based oxide host material, a content of converted nitrous oxide (N₂O) of the gas decomposition catalyst according to Equation 1 below at an operating temperature of 800° C. may be in a range of about 6.5×10⁻⁸ moles per second (mol/s) to about 10.0×10⁻⁸ mol/s:

$$Content of converted nitrous oxide ( {N}_{2} O ) ( mol / s ) = [ ( {N}_{2} O gas content flowing into gas mixer at operating temperature of 800 ° C . ) - ( content of {N}_{2} O gas flowing out to outside of reactor at operating temperature of 800 ° C . ) ] . \qquad Equation 1$$

The gas decomposition catalyst according to an embodiment may have nitrous oxide (N₂O) gas decomposition performance which is about 1.14 times to about 1.6 times higher than that of a gas decomposition catalyst in which a B′ element protrudes from a surface of a perovskite-based oxide host material in which only a B′ element is doped into a B site at an operating temperature of 800° C.

### Scrubber System

According to another embodiment, a scrubber system for decomposing nitrous oxide (N₂O) gas may include a gas inlet through which a process gas flows in, a scrubber including a gas decomposition catalyst which decomposes nitrous oxide (N₂O) gas from the process gas flowing in from the gas inlet, and a gas outlet through which a gas, from which the nitrous oxide (N₂O) gas is removed, flows out from the scrubber, wherein the gas decomposition catalyst includes a perovskite-based oxide host material represented by Formula 1, in which a B′ element and a B″ element that are different each other are each doped into a B site, and one or more B′ element protrusion particles derived from a portion or all of the B′ element on a surface of the perovskite-based oxide host material, wherein the one or more B′ element protrusion particles may have a shape in which a portion of one particle is fixed inside the perovskite-based oxide host material and another portion of the one particle protrudes from the surface of the perovskite-based oxide host material.

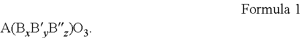

In Formula 1,
A may be at least one element of strontium (Sr) or lanthanum (La),
B may be at least one of metals (e.g. transition metals) having an oxidation number of +3, +4, or +5,
B′ may be at least one of elements of which Gibbs free energy

$$( Δ {G}_{red}^{900 C} )$$

of a reduction reaction at a temperature of 900° C. according to Reaction Formula 1 is 0 or less,
B″ may be at least one element of zirconium (Zr), hafnium (Hf), niobium (Nb), tantalum (Ta), gadolinium (Gd), scandium (Sc), or titanium (Ti),
x, y, and z may each be a rational number that is greater than 0 and less than 1, and
x+y+z=1.

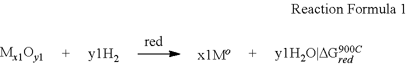

In Reaction Formula 1,
x1 and y1 may each be a positive rational number, and
M may be a metal. For example, M may be at least one of metals (e.g. transition metals) having an oxidation number of +3, +4, or +5.

The scrubber system for decomposing nitrous oxide (N₂O) gas according to an embodiment may be used for treating vehicle exhaust gases, treating semiconductor process gases, or treating process gases for a display such as a liquid crystal display (LCD). The scrubber system may provide a system that decomposes nitrous oxide (N₂O) gas with high efficiency at a high temperature of about 800° C. in an operating environment, thereby preventing an untreated nitrous oxide (N₂O) gas from being discharged.

A scrubber for decomposing nitrous oxide (N₂O) gas according to an embodiment may include one or more reactors each including a combustion chamber in which a process gas flown in is heated, a catalyst chamber into which the heated process gas flows in from the combustion chamber and reacts with a gas decomposition catalyst to decompose nitrous oxide (N₂O) gas, and a heat storage chamber into which the process gas reacting with the gas decomposition catalyst flows from the catalyst chamber.

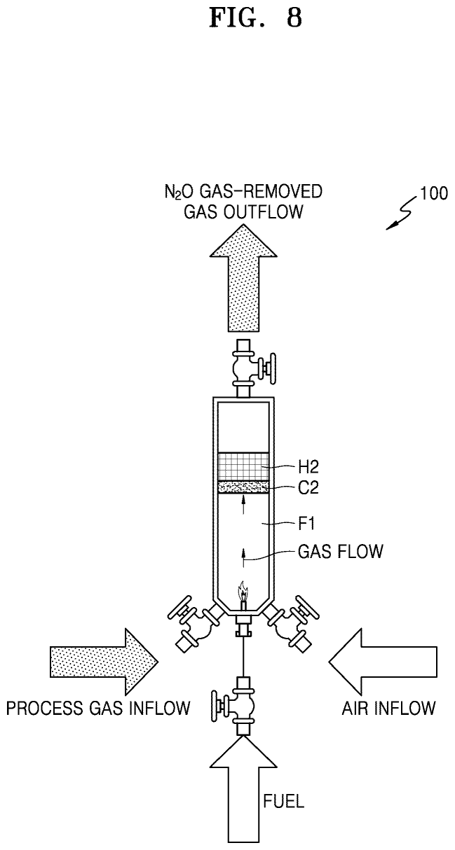

FIG. 8 is a schematic view of a scrubber system 100 for decomposing nitrous oxide (N₂O) gas according to an embodiment.

Referring to FIG. 8, the scrubber system 100 for decomposing nitrous oxide (N₂O) gas according to an embodiment may include a gas inlet through which a process gas flows in, a scrubber including a reactor including a gas decomposition catalyst which decomposes nitrous oxide (N₂O) gas from the process gas flowing in from the gas inlet, and a gas outlet through which a gas, from which the nitrous oxide (N₂O) gas is removed, flows out from the scrubber.

The scrubber system for decomposing nitrous oxide (N₂O) gas according to an embodiment may be designed as follows.

The process gas may flow in from the gas inlet through a valve. Examples of the process gas may include a silane (SiH₄) gas; a hydrogen fluoride (HF) gas; a hydrofluorocarbon gas such as CHF₃ or CH₂F₂; a fluorocarbon gas such as C₂F₄, C₂F₆, C₃F₆, C₃F₈, C₄F₈, or C₄F₁₀; a sulfur fluoride gas such as SF₄ or SF₆; a nitrogen fluoride gas such as NF₃; other gases capable of forming a gaseous product such as HF; and nitrous oxide (N₂O) gas. The process gas may pass through a chemically coated valve and may flow into the scrubber including the gas decomposition catalyst for decomposing the nitrous oxide (N₂O) gas. A valve into which air flows from an air inlet may be installed at the other side of the scrubber. An amount of gas flowing into the scrubber may be adjusted by the valve into which air flows.

A burner may be positioned between the gas inlet and the air inlet and below the scrubber. A valve may be installed directly on a fuel line to adjust a combustion amount of the burner. An amount of input heat may be adjusted through the valve based on an actual temperature of a combustion chamber F1. Additionally, a valve (not shown) connected to a combustion air fan may be installed next to a combustion amount adjustment valve of the burner to prevent the input of excessive combustion air. The inflowing process gas and air may be heated in the combustion chamber F1. The combustion chamber F1 may be maintained at a temperature of, for example, about 800° C. to 850° C.

The process gas heated in the combustion chamber F1 may flow into a catalyst chamber C2 for decomposing nitrous oxide (N₂O) gas and may react with the gas decomposition catalyst. The gas decomposition catalyst may have a shape itself such as a spherical shape, an ellipsoidal shape, a ring shape, or a cylindrical shape or may be molded. A catalytic molding method is not limited, but for example, an extrusion molding method, a tablet molding method, a rotary granulation method, or the like may be used. For example, the gas decomposition catalyst may be molded into a honeycomb shape or a plate shape. Alternatively, the gas decomposition catalyst may be disposed as a bed inside the catalyst chamber C2. For example, a bed on which the gas decomposition catalyst may be disposed in the form of a packed bed (or fixed bed) or a fluidized bed inside the catalyst chamber C2. The process gas flowing into the catalyst chamber C2 may be heated to a temperature at which the process gas may react with a catalyst, for example, a temperature of about 800° C.

A heat storage chamber H2, into which the process gas reacting with the gas decomposition catalyst flows from the catalyst chamber C2, may be installed on the catalyst chamber C2. For the heat storage chamber H2, a heat sink consisting of a ceramic material such as alumina may be used. The heat sink may be used in numbers greater than equal to 100% of an amount of heat required to increase heat recovery efficiency. Additionally, a monolithic type heat sink may be used to minimize pressure loss and power consumption. The process gas flowing into the heat storage chamber H2 may lose heat while passing through the heat sink and may pass through a valve, and thus a gas from which nitrous oxide (N₂O) gas is removed may flow out.

Optionally, in the scrubber system, a gas condenser (not shown) may be additionally installed on the scrubber to remove an untreated nitrous oxide (N₂O) gas before the gas from which the nitrous oxide (N₂O) gas is removed flows out. The gas condenser may condense a vapor gas discharged from the scrubber to form a process condensate. The process condensate may also be used as cooling water for controlling a temperature inside the scrubber by passing through a transfer pipe (not shown) between the gas condenser (not shown) and the scrubber.

Alternatively, in the scrubber system according to an embodiment, when the combustion chamber F1 is installed above a reactor of the scrubber, positions of the catalyst chamber C2 and the heat storage chamber H2 described above may be reversed.

If necessary, in the scrubber system according to an embodiment, before a first reactor is installed, a preliminary heat storage chamber may be installed to preliminarily heat the process gas such that the process gas having a substantially catalyst decomposition temperature flows into the catalyst chamber C2. For example, the preliminary heat storage chamber may be installed between the catalyst chamber C2 and the combustion chamber F1. For the preliminary heat storage chamber, a heat sink comprising the same ceramic material as the heat storage chamber H2 may be used. A degree of temperature increase of the inflowing process gas may be adjusted according to the number of heat sinks used in the preliminary heat storage chamber and an initial temperature.

The scrubber system according to an embodiment may have a structure in which two or more reactors are disposed in parallel.

For example, the scrubber system according to an embodiment may have a structure in which a first reactor in which a first heat storage chamber and a first catalyst chamber are installed and a second reactor in which a second heat storage chamber and a second catalyst chamber are installed are disposed in parallel, and a combustion chamber on which a burner is positioned is disposed.

The scrubber system for decomposing nitrous oxide (N₂O) gas according to an embodiment may have a structure in which, in addition to the first and second reactors disposed in parallel as described above, a third reactor or a fourth reactor is additionally disposed in parallel.

The scrubber system for decomposing nitrous oxide (N₂O) gas may improve the efficiency of treating nitrous oxide (N₂O) gas while minimizing fuel consumption.

Hereinafter, Examples and Comparative Examples will be described. However, the following Examples are merely examples of the disclosure, and the disclosure is not limited to the following Examples.

### EXAMPLES

### Reference Example 1: Sr(Ti_{0.9}Co_{0.1})O₃ Gas Decomposition Catalyst

SrCO₃, TiO₂, and Co₃O₄ were placed into a reactor in a stoichiometric ratio of 1:0.9:0.1 and mixed for about 12 hours to obtain a mixture. The mixture was subjected to oxidation heat treatment at a temperature of about 1,300° C. in an air atmosphere for 16 hours to obtain a Sr(Ti_{0.9}Co_{0.1})O₃ perovskite-based oxide solid solution in which a cobalt (Co) element was solid-solutioned in a perovskite oxide lattice.

The Sr(Ti_{0.9}Co_{0.1})O₃ perovskite-based oxide solid solution was pulverized with a mortar to obtain a pulverized Sr(Ti_{0.9}Co_{0.1})O₃ perovskite-based oxide solid solution (before reduction).

The pulverized Sr(Ti_{0.9}Co_{0.1})O₃ perovskite-based oxide solid solution was subjected to reduction heat treatment at a temperature of 900° C. for 10 hours in an H₂/Ar (5/95, volume per volume (v/v)) atmosphere to prepare a product in which a cobalt (Co) element transformed into a solid-solutioned in a perovskite oxide lattice was ex-solutioned (after reduction). In this case, a Sr(Ti_{0.9}Co_{0.1})O₃ gas decomposition catalyst, in which spherical cobalt (Co) element protrusion particles with a diameter of 13 nm were formed, was prepared from the product.

### Example 1: Sr(Ti_{0.8}Co_{0.1}Zr_{0.1})O₃ Gas Decomposition Catalyst

A Sr(Ti_{0.8}Co_{0.1}Zr_{0.1})O₃ gas decomposition catalyst in which spherical cobalt (Co) element protrusion particles with a diameter of 14.93 nm was prepared in the same manner as in Reference Example 1, except that Sr(CO₃), TiO₂, Co₃O₄, and ZrO₂ were put into a reactor in a stoichiometric ratio of 1:0.8:0.1:0.1 and mixed for about 12 hours to obtain a mixture, and then a Sr(Ti_{0.8}Co_{0.1}Zr_{0.1})O₃ perovskite-based oxide solid solution in which a cobalt (Co) element was solid-solutioned was obtained to obtain a product,.

### Example 2: Sr(Ti_{0.8}Co_{0.1}Hf_{0.1})O₃ Gas Decomposition Catalyst

A Sr(Ti_{0.8}Co_{0.1}Hf_{0.1})O₃ gas decomposition catalyst in which spherical cobalt (Co) element protrusion particles with a diameter of 13.19 nm were formed was prepared in the same manner as in Reference Example 1, except that SrCO₃, TiO₂, Co₃O₄, and HfO₂ were put into a reactor in a stoichiometric ratio of 1:0.8:0.1:0.1.

### Example 3: Sr(Ti_{0.8}Co_{0.1}Nb_{0.1})O₃ Gas Decomposition Catalyst

A Sr(Ti_{0.8}Co_{0.1}Nb_{0.1})O₃ gas decomposition catalyst in which spherical cobalt (Co) element protrusion particles with a diameter of 7.9 nm were formed was prepared in the same manner as in Reference Example 1, except that SrCO₃, TiO₂, Co₃O₄, and Nb₂O₅ were put into a reactor in a stoichiometric ratio of 1:0.8:0.1:0.1.

### Example 4: Sr(Ti_{0.8}Co_{0.1}Ta_{0.1})O₃ Gas Decomposition Catalyst

A Sr(Ti_{0.8}Co_{0.1}Ta_{0.1})O₃ gas decomposition catalyst in which spherical cobalt (Co) element protrusion particles with a diameter of 8.5 nm were formed was prepared in the same manner as in Reference Example 1, except that SrCO₃, TiO₂, Co₃O₄, and Ta₂O₅ were put into a reactor in a stoichiometric ratio of 1:0.8:0.1:0.1.

### Evaluation Example 1: XRD Spectrum Experiment-Crystal Structure

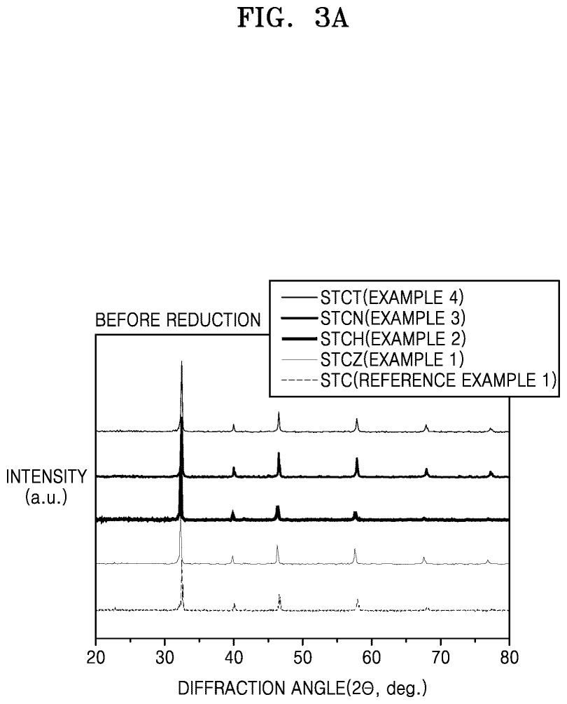

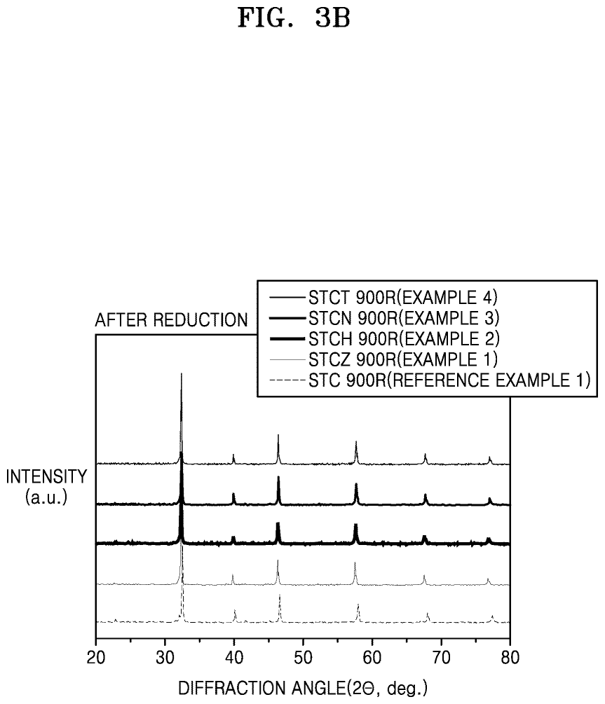

In order to confirm a crystal structure of each of perovskite-based oxide gas decomposition catalysts prepared in Reference Example 1 and Examples 1 to 4 before and after reduction, an X-ray diffraction (XRD) spectrum experiment using CuKα rays was performed. Results thereof are shown in FIGS. 3A and 3B, respectively.

The XRD spectrum experiment was performed at 1 degrees per minute (°/min) at a diffraction angle 2θ ranging from 20° to 80°. Results thereof are shown in FIG. 3A (before reduction and before ex-solution) and FIG. 3B (after reduction and after ex-solution).

Referring to FIGS. 3A and 3B, in all of the perovskite-based oxide gas decomposition catalysts prepared in Reference Example 1 and Examples 1 to 4, a crystal structure was not changed before and after reduction.

Thus, it may be confirmed that the perovskite-based oxide gas decomposition catalysts prepared in Examples 1 to 4 are thermally and chemically stable.

### Evaluation Example 2: SEM Analysis-Particle Size and Density

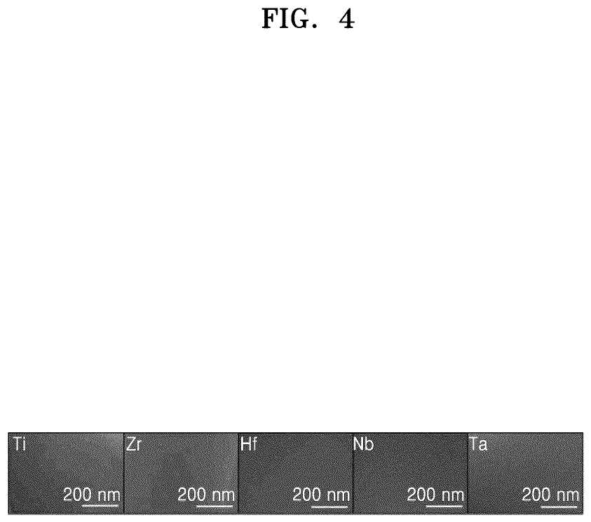

In order to confirm a surface after reduction of each of the perovskite-based oxide gas decomposition catalysts prepared in Reference Example 1 and Examples 1 to 4, SEM analysis was performed. Results thereof are shown in FIG. 4.

As a SEM used for the SEM analysis, SU-9000 manufactured by Hitachi High-Tech Corporation was used.

Referring to FIG. 4, it may be confirmed that the size and distribution of particles ex-solutioned on a surface of each of the perovskite-based oxide gas decomposition catalysts prepared in Reference Example 1 and Examples 1 to 4 change after reduction.

Specifically, the particles ex-solutioned on the surface of the perovskite-based oxide gas decomposition catalysts prepared in Reference Example 1 and Examples 1 to 4 have a shape close to a sphere, such as a sphere or an ellipse.

It may be confirmed that the size of the particles ex-solutioned on the surface of the perovskite-based oxide gas decomposition catalyst prepared in Examples 1 to 4 is gradually decreased, and the particles are more uniformly distributed as compared to the surface of the perovskite-based oxide gas decomposition catalyst prepared in Reference Example 1.

It may be confirmed that a diameter of the particles ex-solutioned on the surface of each of the perovskite-based oxide gas decomposition catalyst prepared in Examples 1 to 4 is in a range of about 5 nm to about 20 nm, and a density thereof is in a range of about 50/μm² to about 1,000/μm².

Evaluation Example 3: Experiment on content of converted nitrous oxide (N₂O)—evaluation of N₂O decomposition performance

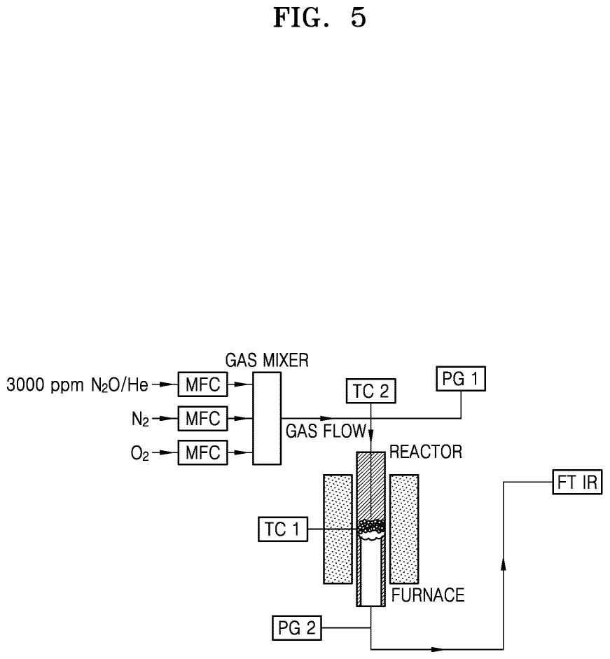

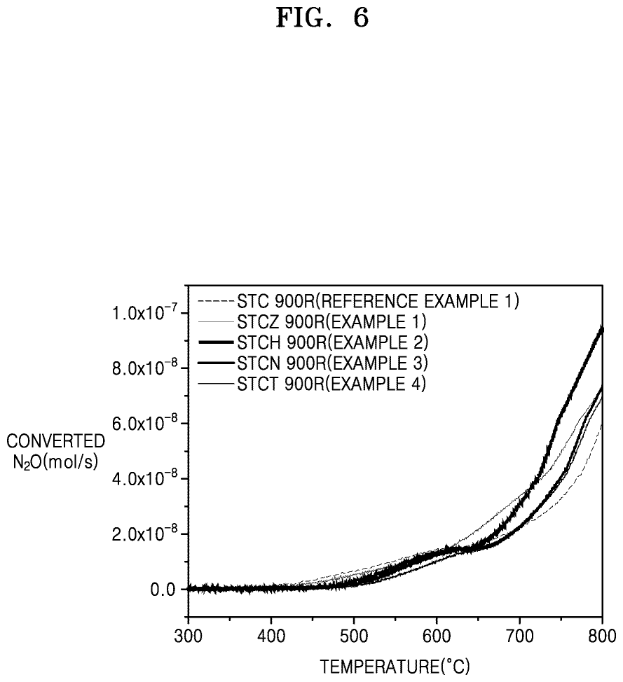

In order to evaluate nitrous oxide (N₂O) gas decomposition performance according to a temperature of each of the perovskite-based oxide gas decomposition catalysts prepared in Reference Example 1 and Examples 1 to 4, a nitrous oxide (N₂O) gas decomposition system according to FIG. 5 described below was manufactured. Results thereof are shown in FIG. 6, and results at an operating temperature of 800° C. are shown in FIG. 7.

Specifically, the nitrous oxide (N₂O) gas decomposition system according to FIG. 5 is as follows.

The perovskite-based oxide gas decomposition catalysts prepared in Reference Example 1 and Examples 1 to 4 are each disposed as a bed inside a reactor. A gas mixer including three mass flow controllers MFC into which 100 standard cubic centimeters per minute (sccm) of N₂O/He mixed gas containing 3,000 parts per million (ppm) N₂O, a N₂ gas, and an O₂ gas flow respectively, a second thermocouple TC2 for measuring a temperature of a gas decomposition catalyst bed, and a first pressure gauge PG1 for measuring pressure are connected to an upper portion of the reactor. Two furnaces for heating the reactor are disposed at both sides of the reactor, and a first thermocouple TC1 is connected to one side thereof. A second pressure gauge PG2 for measuring pressure and a gas concentration meter (FT-IR manufactured by MIDAC cooperation) for measuring a concentration of each gas flowing out to the outside from the inside of the reactor are connected to a lower portion of the reactor.

By using the nitrous oxide (N₂O) gas decomposition system according to FIG. 5, a content of converted nitrous oxide (N₂O) according to a temperature was substituted into Equation 1 and calculated to evaluate the N₂O decomposition performance of each perovskite-based oxide gas decomposition catalyst.

Content of converted nitrous oxide(N₂O)(mol/s)=[(N₂O gas content flowing into gas mixer at operating temperature of 800° C.)−(content of N₂O gas flowing out to outside of reactor at operating temperature of 800° C.)] Equation 1

Referring to FIG. 6, it can be confirmed that the content of the converted nitrous oxide (N₂O) increases as a temperature increases from 300° C. to 800° C. in all of the perovskite-based oxide gas decomposition catalysts prepared in Reference Example 1 and Examples 1 to 4.

Thus, it can be confirmed that the N₂O decomposition performance of all of the perovskite-based oxide gas decomposition catalysts prepared in Reference Example 1 and Examples 1 to 4 increases as a temperature increases.

Among these, N₂O decomposition performance according to an increase in temperature of the Sr(Ti_{0.8}Co_{0.1}Hf_{0.1})O₃ gas decomposition catalyst prepared in Example 2 significantly increased.

Referring to FIG. 7, it can be confirmed that, in all of the perovskite-based oxide gas decomposition catalysts prepared in Examples 1 to 4, at a temperature of 800° C., the content of the converted nitrous oxide (N₂O) was higher, and N₂O decomposition performance was relatively superior as compared to the perovskite-based oxide gas decomposition catalyst prepared in Reference Example 1.

Among these, in the Sr(Ti_{0.8}Co_{0.1}Hf_{0.1})O₃ gas decomposition catalyst prepared in Example 2, the content of the converted nitrous oxide (N₂O) was about 1.6 times higher than that of the perovskite-based oxide gas decomposition catalyst prepared in Reference Example 1.

Therefore, it can be confirmed that the N₂O decomposition performance of the Sr(Ti_{0.8}Co_{0.1}Hf_{0.1})O₃ gas decomposition catalyst prepared in Example 2 is relatively very excellent.

A gas decomposition catalyst according to an aspect may include a perovskite-based oxide host material represented by Formula 1, in which a B′ element and a B″ element that are different from each other are each doped into a B site, and one or more B′ element protrusion particles derived from a portion or all of the B′ element on a surface of the perovskite-based oxide host material. The B′ element protrusion particles may have a shape in which a portion of one particle is fixed inside the perovskite-based oxide host material and another portion of the one particle protrudes from the surface of the perovskite-based oxide host material. The gas decomposition catalyst may be thermally and chemically stable in an operating environment for nitrous oxide (N₂O) decomposition and may have improved nitrous oxide (N₂O) decomposition performance.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the FIGS., it will be understood by those of ordinary skill in the art that various changes in form and details may be made therein without departing from the spirit and scope as defined by the following claims.

What is claimed is:

1. A gas decomposition catalyst comprising:
a perovskite-based oxide host material represented by Formula 1, in which a B′ element and a B″ element that are different from each other are each doped into a B site, and
one or more B′ element protrusion particles derived from a portion or all of the B′ element on a surface of the perovskite-based oxide host material,
wherein the one or more B′ element protrusion particles have a shape in which a portion of one particle is fixed inside the perovskite-based oxide host material and another portion of the one particle protrudes from the surface of the perovskite-based oxide host material: 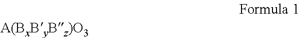
wherein, in Formula 1,
A is at least one element of strontium or lanthanum,
B is at least one of metals having an oxidation number of +3, +4, or +5,
B′ is at least one of element of which Gibbs free energy
$$( Δ {G}_{red}^{900 C} )$$
of a reduction reaction at a temperature of 900° C. according to Reaction Formula 1 is 0 or less,
B″ is at least one element of zirconium, hafnium, niobium, tantalum, gadolinium, scandium, or titanium,
x, y, and z are each a rational number that is greater than 0 and less than 1, and
x+y+z=1: 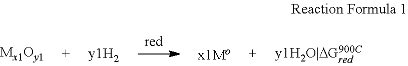
wherein, in Reaction Formula 1,
x1 and y1 are each a positive rational number,
red is reduction, and
M is a metal.

2. The gas decomposition catalyst of claim 1, wherein B comprises at least one element of titanium, aluminum, cobalt, iron, or nickel.

3. The gas decomposition catalyst of claim 1, wherein B′ comprises at least one element of cobalt, nickel, or iron.

4. The gas decomposition catalyst of claim 1, wherein the one or more B′ element protrusion particles have a spherical shape, an ellipsoidal shape, a ring shape, or a cylindrical shape.

5. The gas decomposition catalyst of claim 1, wherein the one or more B′ element protrusion particles are nanoparticles.

6. The gas decomposition catalyst of claim 1, wherein the one or more B′ element protrusion particles have a size of about 5 nanometers to about 20 nanometers.

7. The gas decomposition catalyst of claim 1,
wherein the B″ element is capable of controlling a size and a distribution of the one or more B′ element protrusion particles.

8. The gas decomposition catalyst of claim 1, wherein the one or more B′ element protrusion particles have a density of about 50 per square micrometers to about 1,000 square micrometers on the surface of the perovskite-based oxide host material.

9. The gas decomposition catalyst of claim 1, wherein the B′ element occupies an amount of more than 0 atomic percentage and up to about 75 atomic percentage with respect to a total of 100 atomic percentage at the B site, and
the B″ element occupies an amount of more than 0 atomic percentage and up to about 50 atomic percentage with respect to a total of 100 atomic percentage at the B site.

10. The gas decomposition catalyst of claim 1, wherein the gas decomposition catalyst decomposes nitrous oxide gas.

11. A method of decomposing nitrous oxide gas, the method comprising contacting a gas stream including nitrous oxide gas with a gas decomposition catalyst,
wherein the gas decomposition catalyst comprises:
a perovskite-based oxide host material represented by Formula 1, in which a B′ element and a B″ element that are different from each other are each doped into a B site; and
one or more B′ element protrusion particles derived from a portion or all of the B′ element on a surface of the perovskite-based oxide host material,
wherein the one or more B′ element protrusion particles have a shape in which a portion of one particle is fixed inside the perovskite-based oxide host material and another portion of the one particle protrudes from the surface of the perovskite-based oxide host material: 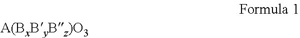
wherein, in Formula 1,
A is at least one element of strontium or lanthanum,
B is at least one of metals having an oxidation number of +3, +4, or +5,
B′ is at least one of elements of which Gibbs free energy
$$( Δ {G}_{red}^{900 C} )$$
of a reduction reaction at a temperature of 900° C. according to Reaction Formula 1 is 0 or less,
B″ is at least one element of zirconium, hafnium, niobium, tantalum, gadolinium, scandium, or titanium,
x, y, and z are each a rational number that is greater than 0 and less than 1, and
x+y+z=1: 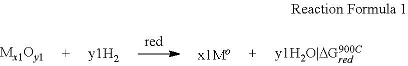
wherein, in Reaction Formula 1,
x1 and y1 are each a positive rational number,
red is reduction, and
M is a metal.

12. The method of claim 11, wherein B comprises at least one element of titanium, aluminum, cobalt, iron, or nickel.

13. The method of claim 11, wherein B′ comprises at least one element of cobalt, nickel, or iron.

14. The method of claim 11, wherein the one or more B′ element protrusion particles are reduced particles formed to be ex-solutioned to the surface of the perovskite-based oxide host material from inside of the perovskite-based oxide host material.

15. The method of claim 11, wherein the B″ element is capable of controlling a size and a distribution of the one or more B′ element protrusion particles.

16. The method of claim 11, wherein, the gas decomposition catalyst is configured to provide a reduction heat treatment at a temperature of 900° C. to form the one or more B′ element protrusion particles on the surface of the perovskite-based oxide host material, a content of converted nitrous oxide of the gas decomposition catalyst according to Equation 1 at an operating temperature of 800° C. is in a range of about 6.5×10⁻⁸ moles per second to about 10.0×10⁻⁸ moles per second:
$$Content of converted nitrous oxide ( moles per second ) = [ ( nitrous oxide gas content flowing into gas mixer at operating temperature of 800 ° C . ) - ( content of nitrous oxide gas flowing out to outside of reactor at operating temperature of 800 ° C . ) ] . \qquad Equation 1$$

17. A scrubber system for decomposing nitrous oxide gas, the scrubber system comprising:
a gas inlet through which a process gas flows in;
a scrubber comprising a gas decomposition catalyst which decomposes nitrous oxide gas from the process gas flowing in from the gas inlet; and
a gas outlet through which a gas, from which the nitrous oxide gas is removed, flows out from the scrubber,
wherein the gas decomposition catalyst comprises: a perovskite-based oxide host material represented by Formula 1, in which a B′ element and a B″ element that are different from each other are each doped into a B site; and
one or more B′ element protrusion particles derived from a portion or all of the B′ element on a surface of the perovskite-based oxide host material,
wherein the one or more B′ element protrusion particles have a shape in which a portion of one particle is fixed inside the perovskite-based oxide host material and another portion of the one particle protrudes from the surface of the perovskite-based oxide host material: 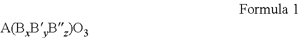
wherein, in Formula 1,
A is at least one element of strontium or lanthanum,
B is at least one of metals having an oxidation number of +3, +4, or +5,
B′ is at least one of elements of which Gibbs free energy
$$( Δ {G}_{red}^{900 C} )$$
of a reduction reaction at a temperature of 900° C. according to Reaction Formula 1 is 0 or less,
B″ is at least one element of zirconium, hafnium, niobium, tantalum, gadolinium), scandium, or titanium,
x, y, and z are each a rational number that is greater than 0 and less than 1, and
x+y+z=1: 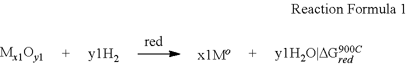
wherein, in Reaction Formula 1,
x1 and y1 are each a positive rational number, and
M is a metal.

18. The scrubber system of claim 17, wherein the scrubber system comprises:
a combustion chamber in which the process gas flown in is heated;
a catalyst chamber into which the process gas heated flows from the combustion chamber and reacts with the gas decomposition catalyst to decompose the nitrous oxide gas; and
one or more reactors comprising a heat storage chamber into which the process gas reacting with the gas decomposition catalyst flows from the catalyst chamber.

19. The scrubber system of claim 18, wherein the gas decomposition catalyst has a shape itself or a molded form or is disposed as a bed inside the catalyst chamber,
wherein the shape is a spherical shape, an ellipsoidal shape, a ring shape, or a cylindrical shape.

20. The scrubber system of claim 18, having a structure in which the one or more reactors comprise two or more reactors disposed in parallel.
